(19) United States
(12) Patent Application Publication
(10) Pub. No.: US 2026/0317143 A1
(43) Pub. Date: Oct. 15, 2026

(54) LEVER TOOL SUITABLE FOR STRIPPING NAILED FORMWORK BOARDS

(71) Applicant: SISTEMAS TÉCNICOS DE ENCOFRADOS S.A., Barcelona (ES)

(72) Inventor: José Luis UBIÑANA FÉLIX, Barcelona (ES)

(21) Appl. No.: 19/122,637

(22) PCT Filed: Oct. 21, 2022
(86) PCT No.: PCT/ES2022/070678

§ 371 Date: Apr. 18, 2025

(51) Int. Cl. B66F 15/00

(52) U.S. Cl. CPC B66F 15/00

(57) ABSTRACT

The present lever tool (1) is suitable for the stripping of boards (T) nailed to beams (V), and comprises two longitudinal arms (11) arranged symmetrically with respect to a median plane and articulatedly joined by one of its longitudinal ends, its other longitudinal ends comprising two heads (12) whose adjacent faces have fulcrum elements (13) provided with a pushing segment (131) and a support segment (132), where the pushing segment (131) and/or the support segment (132) define a lever resistance arm by means of a portion (1311) projected perpendicular to the longitudinal direction of the longitudinal arms (11) and parallel to said median plane.

### FIELD OF THE INVENTION

The present invention relates to a tool suitable for stripping boards that are nailed to the beams of a formwork.

### BACKGROUND OF THE INVENTION

Formwork is often constructed with boards that are nailed to formwork beams and which need to be subsequently removed to be reused in new formwork.

Usually, a hammer or a tool known as a pry bar is used as a lever, which is inserted between the board and the beam to be unlocked. However, there are a number of disadvantages inherent in this method of formwork stripping. The main disadvantage of this tool is that it often causes considerable damage to both the boards and the beams. Another way of stripping the boards is by rotating the beams, but then the nails are twisted and removing them requires additional effort.

Therefore, there is still a need for a solution to strip the boards with reduced deterioration thereof and a lower effort on the part of the operator.

### DESCRIPTION OF THE INVENTION

The purpose of this invention is to provide a tool that, using the principle of the lever, helps to strip boards that are nailed to the beams of a formwork. Specifically, the present tool is suitable for formwork using beams of the type which, apart from a central body, comprise two protrusions or lateral flanges that can serve as a support to provide leverage against the roof, so that at least said protrusions do not coincide longitudinally with the end of the central body intended to be adjacent to the boards (that is, said protrusions that serve as a support are not located at the upper end of the beam as seen in its condition of use).

The present tool is characterized in that it comprises two longitudinal arms arranged symmetrically with respect to a median plane and joined in an articulated manner by one end (in particular, the lower end, that is, the one that the user holds in the normal position of use), such that they define an open position when the longitudinal arms are in an oblique position with respect to the median plane and a closed position when they are in a position parallel to it. In addition, the upper ends of the longitudinal arms comprise two heads, which can be curved portions of the same arms or be elements added to the arms. Furthermore, two adjacent faces of the heads have fulcrum elements, which, in addition, can be portions of the same heads or be elements added to the heads. These fulcrum elements are configured such that when the longitudinal arms are in their condition of use in which they cannot be closed more (i.e. when the fulcrums or the heads contact the beam on each side), a space is defined between them equal to or slightly greater than the width of the central body of the beams and less than the width between the ends of said lateral protrusions. In addition, each fulcrum element is provided with at least:
a pushing segment whose edge is intended to push the boards located above said beams, that is located adjacent to the unarticulated end of the respective longitudinal arm (i.e., the pushing segment forms the upper end of the fulcrum as seen in its normal position of use and is at the same time adjacent to the upper end of the respective longitudinal arm), and
a support segment whose edge is intended to rest on a respective lateral projection of the beams, being located at the longitudinal end opposite the pushing segment (i.e. located at the lower end of the fulcrum as seen in its normal position of use).

Specifically, the support segment and/or the pushing segment define a lever resistance arm (i.e., the minimum or perpendicular distance between the support point of the support segment and the line of action of the force that is resistant to lever movement) by a portion projected perpendicularly to the longitudinal direction of the longitudinal arms and parallel to said median plane. At the same time, the fulcrum has a smaller dimension defined by the perpendicular length (or minimum distance) existing between the end surfaces of the support segment and the pushing segment. In order for the fulcrum to fit in said space (in particular in the initial position of the lever movement) said perpendicular length is slightly less than the space available between the lateral projections and said end of the central body intended to be adjacent to the boards.

As is expected, the fulcrum has dimensions greater than said perpendicular length in directions that do not coincide with same, so that, when the support segments are resting on the lateral protrusions and a user applies leverage with the longitudinal arms (that is, pushes the articulated end of the longitudinal arms so that they perform a pivoting movement with respect to the support segment in a path comprised in said median plane), the pushing segment pushes the boards vertically with respect to the corresponding beams, managing to separate them and unlock them with little effort, and without bending the nails or damaging the boards.

In a preferred embodiment, the pushing segment and/or the support segment comprise a cam-shaped edge, whose geometry is configured so that the lever resistance arm generated between the contact points of the fulcrum progressively increases as its contact point moves away from the perpendicular length as soon as the lever movement begins. To do this, the fulcrum has a geometry such that the distance between the end surfaces of the pushing segment and the support segment varies proportionally to the increase of the resistance arm as its point of contact moves away from the perpendicular length. In other words, the variation of the distance between the pushing segment and the support segment is more pronounced the closer it is to said perpendicular length. In this way, the pushing segment transmits to the boards a gradual pushing force along the movement of the lever.

In a possible embodiment, the longitudinal arms comprise a stop element of the opening configured so that the fulcrum elements can be separated by a distance not much greater than the width of the beams. For example, the stop element consists of a pin with a threadable nut at the end and a transverse hole through the longitudinal arms, which receives the pin.

Preferably, the longitudinal arms consist of metal profiles, while the fulcrum elements consist of laminar pieces fixed to the longitudinal arms, which are manufactured by cutting procedures, such as for example by laser or by die-cutting.

As can be deduced, in order for the edges of both pushing segments of the lever tool to contact the boards, the distance between them must be greater than the width of the upper portion of the beams. For example, when the beams also have upper side protrusions, the geometry of the fulcrums must be such that the pushing segments protrude sideways sufficiently to contact the boards.

### BRIEF DESCRIPTION OF THE DRAWINGS

FIG. 1 is a front view of a first example of embodiment of the lever tool.

FIG. 2 is a side view of the first embodiment of the lever tool.

FIG. 3 is a side view of three moments of the travel of the lever tool during its application when separating a beam of from board.

FIG. 4 is a front view of a second example of embodiment of the lever tool.

FIG. 5 is a side view of the second embodiment of the lever tool.

### DESCRIPTION OF PREFERRED EMBODIMENTS

In view of the aforementioned figures and in accordance with the adopted numbering, three examples of embodiment of the lever tool (1, 1′) are described below.

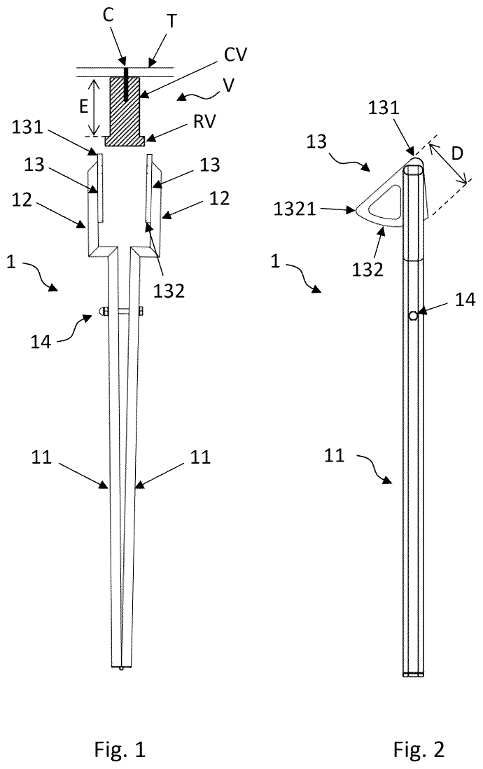

As can be seen in FIG. 1, the present lever tool (1, 1′) is suitable for formwork using beams (V) of the type comprising a central body (CV) and two lateral protrusions (RV) that serve as support for leveraging against the boards (T). In this case, the beam (V) has an inverted T shape, that is, it comprises only two lateral projections (RV) coinciding longitudinally with the lower end of the central body (CV) as seen in its condition of use.

The present embodiments of the lever tool (1, 1′) comprise two longitudinal arms (11) arranged symmetrically with respect to a median plane and joined in an articulated manner by their lower end. On the other hand, the upper ends of the longitudinal arms (11) comprise two heads (12), which in these embodiments consist of welded portions of metal profiles. In addition, two adjacent faces of the heads (12) have fixed fulcrum elements (13, 13′) configured such that when the longitudinal arms (11) are in a condition of use in which they cannot be closed any more, a separation is defined similar to the width of the central body (CV) of the beams (V) and less than the width between the ends of said lateral projections (RV). In addition, each fulcrum element (13, 13′) is provided with:
a pushing segment (131, 131′) whose edge, which is intended to push the boards (T) located above said beams (V), is located adjacent to the upper end of the respective longitudinal arm (11), and
a support segment (132, 132′) whose edge, which is intended to rest on a respective lateral projection (RV), is located at the longitudinal end opposite to that of the pushing segment (131, 131′), i.e., at the lower end of the fulcrum (13, 13′).

FIG. 1 shows the first example of the lever tool (1), in which the support segment (132) defines a lever resistance arm by means of a portion (1321) projected perpendicular to the longitudinal direction of the longitudinal arms (11) and parallel to said median plane. In order for the fulcrum (13) to fit in the space (E) available between the lateral protrusions (RV) and the board (T) at the start of the lever movement, the smaller dimension of the fulcrum (13), which is defined by the perpendicular length (D) existing between the edge of the support segment (132) and the edge of the pushing segment (131), is slightly smaller than said space (E).

As shown in FIG. 2, the support segment 132 of this first embodiment comprises a cam-shaped edge, the distance from the edge of the pushing segment 131 increasing more gently as it moves away from the line of said perpendicular length D.

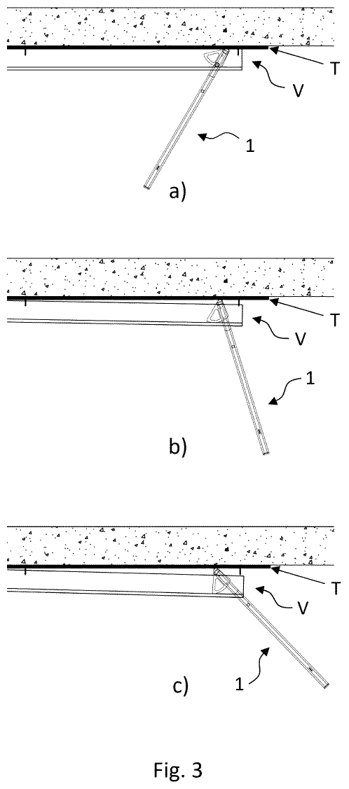

As has been represented at the instants a), b) and c) of the travel of the lever tool (1) of FIG. 3, when both support segments (132) of the lever tool (1) are supported on the lateral protrusions (RV) and a user applies leverage with the longitudinal arms (11), the pushing segment (131) vertically pushes the boards (T) with respect to the corresponding beams (V), managing to separate them and unlock them with little effort, without bending the nails (C) or deteriorating the boards (T). In addition, thanks to the cam shape, the lever resistance arm generated between the contact points of the fulcrum (13) increases gently as lever movement progresses, so the effort is gradual.

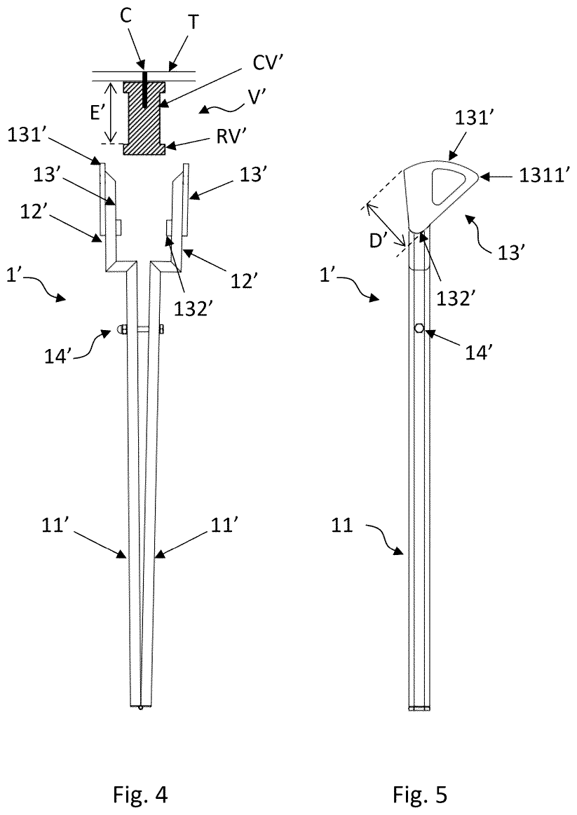

A second example of embodiment of the lever tool (1′) is shown in FIGS. 4 and 5. In this embodiment it is the pushing segment (131′) whose edge is cam-shaped and which defines the lever resistance arm by means of a portion (1311′) projected perpendicular to the longitudinal direction of the longitudinal arms (11′) and parallel to said median plane. As in the previous embodiment, the perpendicular length (D′) existing between the edge of the support segment (132′) and the edge of the pushing segment (131′), is slightly smaller than the space (E′) available between the lateral protrusions (RV′) and the board (T). In turn, FIG. 4 shows a second type of beam (V′), which is I-shaped, that is, it comprises two upper side protrusions and two lower side protrusions (RV)′, as seen in their position of use. In order for the edges of both pushing segments (131′) to contact the board (T), the distance between them must be greater than the width of the upper side protrusions. In this way, when both support segments (132′) are supported on the lower side protrusions (RV′) and a user applies leverage with the longitudinal arms (11′), the pushing segment (131′) transmits the force to the board (T).

As can be seen, the longitudinal arms (11, 11′) of both embodiments comprise a stop element (14, 14′) of the opening, configured so that the fulcrum elements (13, 13′) can be separated a distance not much greater than the width of the beams (V, V′). Specifically, the stop element (14) consists of a pin with a threadable nut at the end and a transverse hole that crosses the longitudinal arms (11, 11′), which receives the pin.

1. A lever tool suitable for stripping boards nailed to formwork beams, the formwork beams comprising a central body and at least one lateral protrusion on each side of the central body, two lateral protrusions longitudinally coinciding with each other and not coinciding with the end of the central body intended to be adjacent to the boards, the lever tool characterized in that it comprises two longitudinal arms arranged symmetrically with respect to a median plane and joined in an articulated manner by one of its longitudinal ends, such as to define an open position in which the longitudinal arms are in an oblique position with respect to a median plane and a closed position in which they are in a position parallel to it, the other longitudinal ends thereof comprising two heads whose faces adjacent to each other have fulcrum elements configured such that, when the longitudinal arms are in a condition of use which can not be closed any further, a space is defined between them equal to or greater than the width of the central body of the formwork beams and less than the width between the ends of the two lateral protrusions, each fulcrum element being provided with:
a pushing segment whose edge is intended to push the boards located above said formwork beams, being the pushing segment located adjacent to the non-articulated end of the respective longitudinal arm, and
a support segment whose edge is intended to be supported on a respective lateral protrusion, being the support segment located at the longitudinal end opposite to that of the pushing segment,
wherein the pushing segment and/or the support segment define a lever resistance arm by a portion projected perpendicular to the longitudinal direction of the longitudinal arms and parallel to said median plane,
where one of the dimensions of the fulcrum is defined by a perpendicular length existing between the edge of the pushing segment and the edge of the support segment, said perpendicular length being slightly smaller than a space available between the lateral protrusions and said end of the central body intended to be adjacent to the boards.

2. The lever tool, according to claim 1, wherein the edge of said portion of the support segment and/or of the pushing segment is cam-shaped so that said lever resistance arm progressively increases as its point of contact moves away from the line of the perpendicular length.

3. The lever tool, according to claim 2, wherein the variation of the distance between the pushing segment and the support segment is more pronounced the closer said perpendicular length is to the point of contact.

4. The lever tool, according to claim 1, wherein the longitudinal arms comprise a stop element of the opening configured so that the fulcrum elements can be separated a distance not much greater than the width of the beams.

5. The lever tool, according to claim 4, wherein the stop element consists of a pin with a threadable nut at the end and a transverse hole that crosses the longitudinal arms, which receives the pin.

6. The lever tool, according to claim 1, wherein the longitudinal arms consist of metal profiles.

7. The lever tool, according to claim 1, wherein the fulcrum elements consist of laminar pieces fixed to the longitudinal arms, which are manufactured by cutting procedures.

8. The lever tool, according to claim 1, wherein the distance between the edges of the two pushing segments is greater than the width of the upper portion of the beams.
